(19) United States
(12) Patent Application Publication
(10) Pub. No.: US 2008/0193051 A1
(43) Pub. Date: Aug. 14, 2008

(54) IMAGE FORMING PROCESSING APPARATUS AND METHOD OF PROCESSING IMAGE FOR THE SAME

(75) Inventor: Kazumi Murata, Mishima-shi (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 11/674,017

(22) Filed: Feb. 12, 2007

(51) Int. Cl. G06K 9/03

(52) U.S. Cl. 382/309

(57) ABSTRACT

An image forming apparatus of the invention outputs page number position information to indicate a position of a page number on an original document, generates image data of the original document by optically reading the original document to which the page number is given, compares, from the generated image data of each of a plurality of original documents, page numbers of the plurality of original documents subjected to an OCR processing based on the page number position information, detects missing of an original document among the plurality of read original document, determines that an abnormality exists in the image data corresponding to the missing original document, and re-reads the original document corresponding to the image data determined to be abnormal among the stored respective image data, and therefore, since the image data of only the page of the missing original document among the plurality of pages is captured, the convenience of the user is improved.

### BACKGROUND OF THE INVENTION

1. Field of the Invention

The present invention relates to an image forming apparatus suitable for use in an MFP (Multi Function Peripheral) having an OCR (Optical Character Recognition) function, and a method of processing an image for the same.

2. Description of the Related Art

At the time of copying of a plurality of original documents, page omission (or missing of page) can occur. As a technique of confirming the page omission, there is a copying apparatus in which a position where a page number is entered on an original document is previously designated, and the page number at the designated position is read from the original document by a reading sensor at the time of copying (JP-A-5-273812). Besides, there is also proposed a page error check apparatus in which code information indicated by a code image included in a specified check region in original document image data of each page is recognized, it is determined based on the code information whether or not the page of the original document image data satisfies a specified page consistency rule, and an error of consistency between pages is detected (JP-A-2005-251050). There is also proposed a scanner apparatus which includes a sensor to detect that a plurality of original documents are taken in and counter means for counting the number of the taken-in original documents, and urges the user to again scan a portion where page omission occurs (JP-A-2001-273478).

### BRIEF SUMMARY OF THE INVENTION

It is an object of the present invention to provide an image forming apparatus having an OCR function.

In an aspect of the present invention, an image forming apparatus includes means for setting page number position information to indicate a position of a page number on an original document, reading means for generating image data of the original document by optically reading the original document to which the page number is given, means for detecting missing of an original document by comparing page numbers between a plurality of original documents subjected to an OCR processing based on the page number position information and for determining that an abnormality exists in image data corresponding to the missing original document and stored in storage means, and additional input processing means for causing the reading means to re-read the original document corresponding to the abnormal image data.

### DESCRIPTION OF THE DRAWINGS

FIG. 1 is a block diagram showing a structure of an image forming apparatus of an embodiment of the invention and a terminal.

FIG. 2A to FIG. 2C are views for explaining a setting method of a position of a page number using recommended information.

FIG. 3A to FIG. 3C are views for explaining a setting method of a position of a page number using image data of each page of a plurality of read original documents.

FIG. 4 is a view for explaining a setting method of a position of a page number using an original document on which an area of a page number is entered.

FIG. 5 is a flowchart for explaining an input processing routine by an image processing method according to an embodiment of the invention.

FIG. 6 is a flowchart for explaining an additional input processing routine by the image processing method according to the embodiment of the invention.

### DETAILED DESCRIPTION OF THE INVENTION

Throughout this description, the embodiments and examples shown should be considered as exemplars, rather than limitations on the apparatus and methods of the present invention.

Hereinafter, embodiments of the invention will be described in detail taking the attached drawings as examples.

Incidentally, in the respective drawings, the same portions are denoted by the same reference numerals and their duplicate description will be omitted.

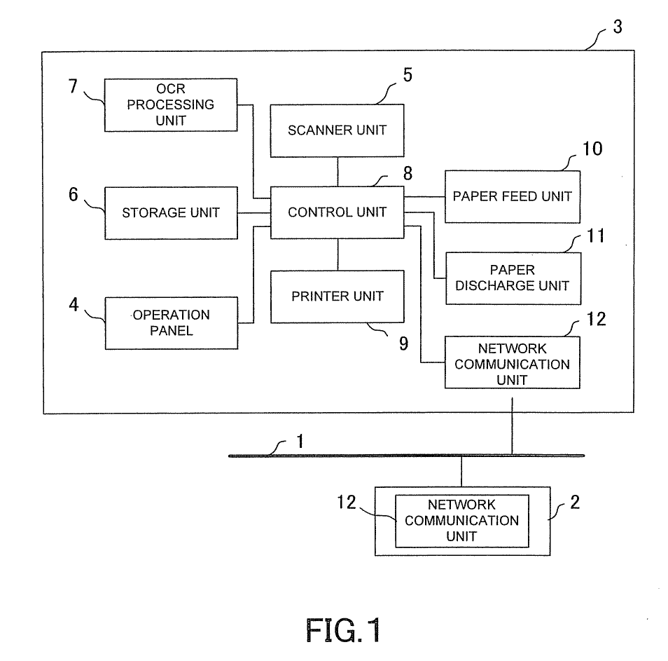

As shown in FIG. 1, a client-server system according to an embodiment of the invention includes a network 1 connected to a server (not shown), a client PC 2 as a terminal connected to the network 1, and an image forming apparatus 3 connected to the client PC 2 through the network 1. The image forming apparatus 3 includes an operation panel 4, a scanner unit 5, a storage unit 6, an OCR processing unit 7, a control unit 8, a printer unit 9, a paper feed unit 10, a paper discharge unit 11, and a network communication unit (communication unit) 12.

The operation panel 4 is, for example, a touch panel, and is used for data input by a user and for displaying information. The position of a page number subjected to an OCR processing is set by the operation panel 4 and the scanner unit 5, so that the reading place of the page position (position of the page number) on an original document is selected. Besides, the function of page number position information setting means for setting page number position information to indicate the position of a page number on a sheet is realized by a ROM and a RAM.

The scanner unit 5 is reading means for generating image data of an original document by optically reading the original document to which the page number is given.

The storage unit 6 is image data storage means for storing image data of each of a plurality of original documents. A hard disk drive and a RAM are used for the storage unit 6.

The OCR processing unit 7 is page number management means for comparing, from the image data of each of the plurality of original documents generated by the scanner unit 5, page numbers of the plurality of original documents subjected to the OCR processing based on the page number position information, detecting missing of an original document among the plurality of original documents read by the scanner unit 5, and determining that an abnormality exists in image data corresponding to the missing original document. The OCR processing unit 7 reads a portion indicating a page number, such as 1 or 2, from the original document. In the case where the abnormality is detected, the OCR processing unit 7 sets the abnormal data. In the case where a re-reading processing of the original document is performed, the OCR processing unit 7 functions also as data addition means for adding data by additional input.

In the case where missing of a page occurs when a plurality of original documents are read, the image forming apparatus of the embodiment notifies the user that the abnormality of reading occurs, and also performs a processing of re-reading the original document of the missing page. The OCR processing unit 7 compares the respective page numbers of the image data of the original document re-read by the scanner unit 5 and the image data of the missing original document. In the case where it is determined that there is no abnormality in the image data of the re-read original document, the image data of the re-read original document is written in the storage unit 6.

The control unit 8 develops the data stored in the storage unit 6, and performs control for changing a processing method such as reading of data, reading of additional data, or addition of data to a file in the storage unit 6. This control unit 8 is also additional input processing means for causing the scanner unit 5 to re-read the original document corresponding to the image data determined to be abnormal by the OCR processing unit 7 among the respective image data stored in the storage unit 6. In the case where the setting of the abnormal data is performed by the OCR processing unit 7, the control unit 8 enables the additional input processing by the scanner unit 5 or the like. Besides, the OCR processing unit 7 and the control unit 8 function as a detection control unit to perform page management using the read image data. The function of the OCR processing unit 7 and the control unit 8 are realized by the CPU, ROM, RAM, LSI or the like.

The printer unit 9 prints an image on a sheet, and the paper feed unit 10 takes in a sheet by the designation from the control unit 8. The paper discharge unit 11 is for discharging the sheet printed by the printer unit 9. The network communication unit 12 is for transmitting and receiving data, such as an image stored in the storage unit 6, to and from the client PC 2 or a higher rank apparatus.

In an image processing method of the image forming apparatus 3 of the invention, page number position information is generated through the operation panel 4, the scanner unit 5 generates image data of an original document to which a page number is given, and the OCR processing unit 7 detects missing of an original document among a plurality of read original documents. The OCR processing unit 7 determines that an abnormality exists in image data of the storage unit 5, and the OCR processing unit 7 causes the scanner unit 5 to re-read the original document corresponding to the image data determined to be abnormal among respective image data of the storage unit 5. As stated above, the image processing method of the invention is the original document reading method of the image forming apparatus 3 having the function to manage the page number subjected to the OCR processing, that is, the method of the OCR page processing.

The image forming apparatus 3 uses either one of three kinds of methods described below and sets the position of the page number subjected to the OCR processing.

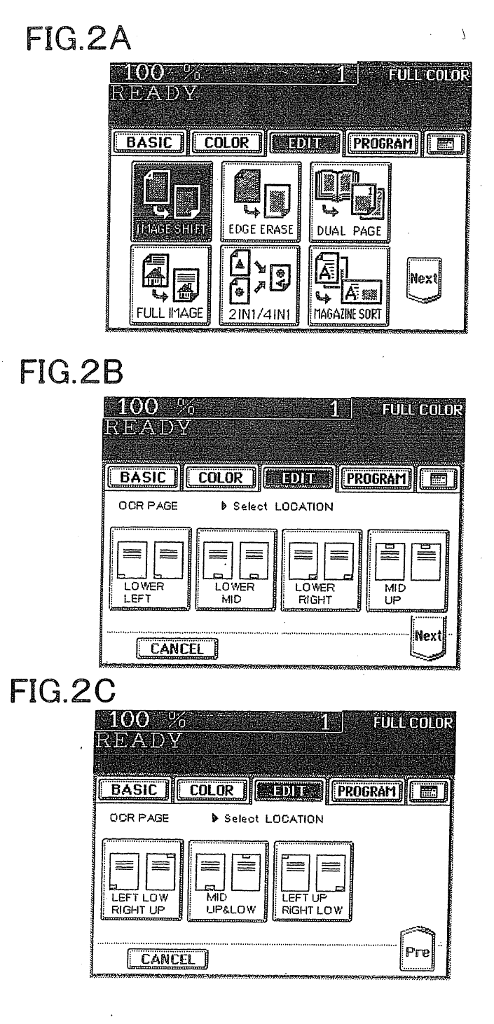

A first method is a method of using recommended information indicating a portion of a page position. FIG. 2A is a view showing an example of a plurality of operation menus displayed by the operation panel 4, and FIGS. 2B and 2C are views each showing an example of a plurality of recommended information displayed by the operation panel 4. In the case where the recommended information is used, the user depresses the menu of page position setting (OCR PAGE LOCATION) among the plurality of operation menus of FIG. 2A. The operation panel 4 displays the plurality of recommended information such as the left end, middle, or right end at the lower part of the sheet, or the upper part or lower part at the middle of the sheet, or the lower part at the left end of the sheet or the upper part at the right end of the sheet, or the upper part of the left end of the sheet or the lower end of the right end of the sheet (FIGS. 2B and 2C). The user selects recommended information among the plurality of recommended information held in the image forming apparatus 3 itself. The selected recommended information is set as page number position information # by the CPU, ROM, RAM or the like. The image forming apparatus 3 sets, as the reading position or the OCR position of the page by the OCR processing, the recommended information selected by the user.

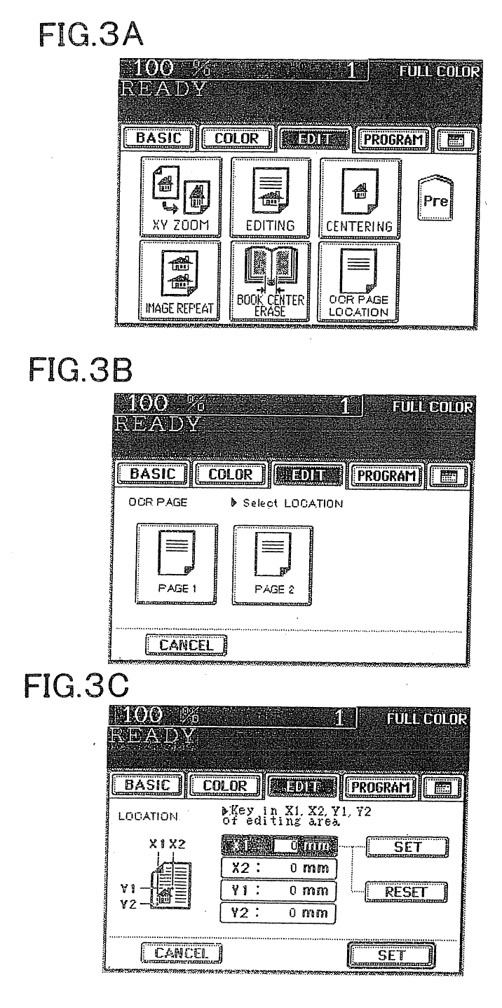

A second method is a method in which the user sets the OCR position for each page of the plurality of read pages. FIG. 3A shows an example of a plurality of operation menus displayed by the operation panel 4. FIG. 3B shows a display example of the operation panel 4 in the middle of the reading processing in the scanner unit 3. FIG. 3C shows an example of simple image data of the plurality of original documents read by the scanner unit 3 and displayed by the operation panel 4. When the operation menu of page position setting among the plurality of operation menus is depressed, the scanner unit 5 starts reading of the plurality of original documents (FIG. 3A). The scanner unit 5 reads partial original documents, such as the first page and the second page, among the plurality of original documents, and generate image data of each of the read original documents (FIG. 3B). The OCR processing unit 7 extracts the portion where the page position exists from the image data, and the operation panel 4 displays, as a simple image, the content of the image data extracted and obtained and the page position in the image data (FIG. 3C). The user sets the OCR position in accordance with the content of the simple image.

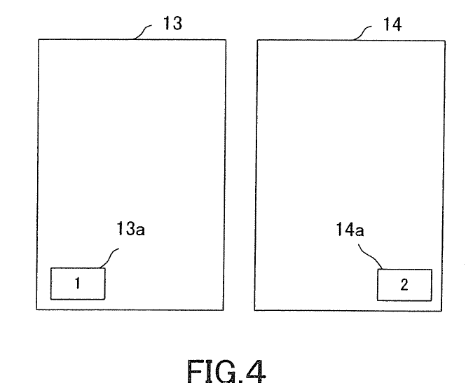

A third method is a method of reading an original document on which an area indicating a page number is entered. FIG. 4 is a view showing an example of the original document on which the area indicating the page number is entered. When the scanner unit 3 reads an area 13a entered on the first page original document 13 and an area 14a entered on the second page original document 14, the page number position information setting means sets the position of the page number subjected to the OCR to be the lower left or the lower right of the page. The image forming apparatus 3 reads the area of the page number entered on the first page original document 13 or the second page original document 14 based on the designated area, and then, detects the same place as the portion of the already read page number with respect to the positions of page numbers of remaining original documents.

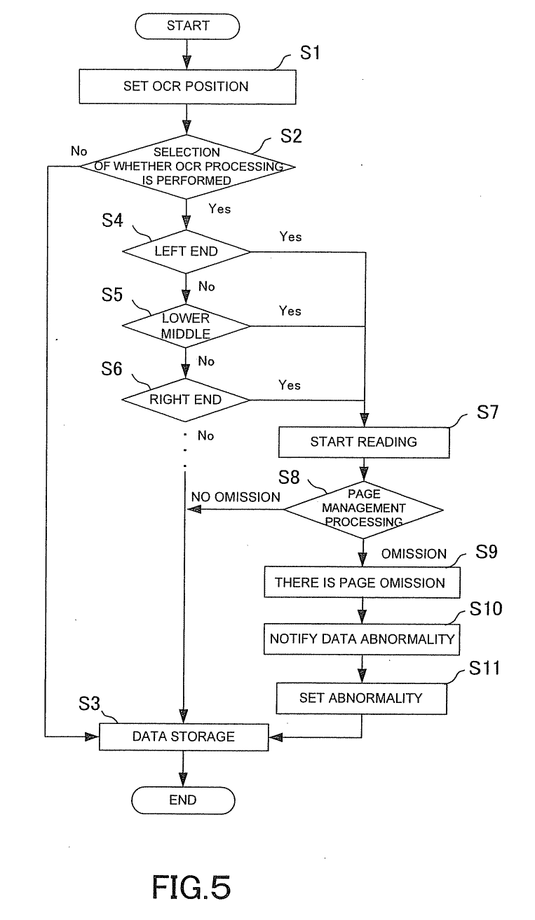

Next, a processing in the case where the image forming apparatus 3 reads an original document by using the setting method of FIGS. 2A to 2C will be described. FIG. 5 is a flowchart for explaining an input processing routine by an image processing method according to an embodiment of the invention. The user selects either one of the plurality of recommended information, such as the left end, lower middle, right end, middle upper part, or lower part, by the operation panel 4, so that the OCR position is set (step S1). After this selection, the scanner unit 5 reads the plurality of original documents.

The image forming apparatus 3 selects, at step S2, whether or not the OCR page processing is executed. In the case where the OCR page processing is executed, the processing passes the No route, and the image forming apparatus 3 stores, at step S3, the read image data in the storage unit 6. At step S2, in the case where the image forming apparatus 3 executes the OCR page processing, the processing passes the Yes route, and the image forming apparatus 3 sets the read position in the page at step S4 to step S6.

In the case where the recommended information of the left end of the sheet is selected at step S1, the image forming apparatus 3 sets the reading position in the page to the left end (step 4). Besides, in the case where the recommended information of the lower middle of the sheet is selected at step S1, the processing passes the No route of step S4, and the image forming apparatus 3 sets the read position in the page to the lower middle (step S5). Besides, in the case where the recommended information of the right end of the sheet is selected at step S1, the processing passes the No route of step S5, and the image forming apparatus 3 sets the read position in the page to the right end (step S6). By this, the designated place or portion in the page is determined.

At step S4, step S5 or step S6, when the read position in the page is determined, the processing passes either one of the Yes routes, and at step S7, the image forming apparatus 3 starts reading of the original document, performs the OCR processing on the page position, and at step S8, performs the page management processing. The control unit 8 compares whether the data of the read page number is data older by one than the page number on the page whose image is generated. This comparison is repeated and the presence or absence of page omission is detected. At step S8, the processing of reading the original documents in turn is continued, and in the case where the OCR processing unit 7 determines that there is no page omission, the processing passes the No route, and the image data of the plurality of original documents are stored in the storage unit 6 (step S3).

On the other hand, at step S8, in the case where double feeding of the original document or the like occurs in the scanner unit 5, the processing passes the Yes route, the OCR processing unit 7 determines that there is page omission (step S9), and the abnormality is detected. The OCR processing unit 7 notifies the user that the abnormality exists in the data of the page number. That is, it is notified to the user through the network communication unit 12, the network 1, and the network communication unit 12 in the client PC 2 that the abnormality exists in the data (step S10). The notification that the abnormality exists is performed such that the number of the missing page or the like is notified to the user.

Also in the case where the image forming apparatus 3 reads part of the plurality of original documents, or in the case where the original document on which the area indicating the page number is entered is read, the image forming apparatus 3 performs the same processing as the processing of FIG. 5.

Besides, the page management unit performs the setting that the abnormality exists for the image data of the page detected to be abnormal (step S11), and the file of the abnormal data is selected, so that the original document having the page number on which the abnormality is detected is again read, and the additional processing is performed on the image data of the read original document.

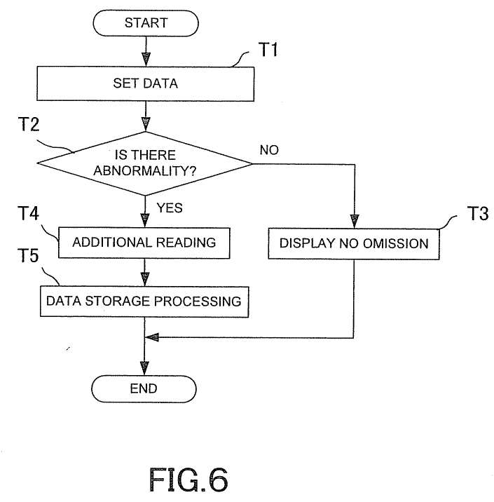

FIG. 6 is a flowchart for explaining an additional input processing routine of the image processing method according to the embodiment of the invention. In the routine of the additional input processing, as shown in FIG. 6, the OCR processing unit 7 selects the read data (step T1), and determines whether or not an abnormality exists in the data (step T2). In the case where the OCR processing unit 7 determines that the data is not abnormal, the processing passes the route to which “NO” is given, and it is determined that there is no page omission of the original document, and no omission is displayed (step T3). In the case where the OCR processing unit 7 determines that the data is abnormal, the processing passes the route to which “YES” is given, the scanner unit 5 additionally or supplementarily reads the original document of the abnormal page (step T4), and stores the read image data (step T5).

Besides, the data is stored also as the abnormal data, and the user opens the file and can see the data. Accordingly, the user can again confirm the original document on which the page omission occurs by the notification that there is abnormality by the client PC 2 and the confirmation of the image data of the file subjected to the read processing, and can recognize the page of the original document added and read.

As stated above, according to the invention, since the setting of the position of the page subjected to the OCR processing is simply performed by the image forming apparatus 3 by using the method of selecting the recommended information or the like, the convenience of the user can be improved. Besides, in order to set the position of the page number, the method of using the read data, or the method of entering the area on the original document can be used, and the abnormality is detected also by these methods.

Besides, according to the invention, in the case where page omission occurs, the setting is performed such that there is an abnormality in the data stored in the storage unit 6, the additional processing is made possible, and the abnormality display and the additional input processing are performed, so that the input of reading only a part of data is performed, and accordingly, it is not necessary to read all data, and the convenience of the user is improved.

Although exemplary embodiments of the present invention have been shown and described, it will be apparent to those having ordinary skill in the art that a number of changes, modifications, or alternations to the invention as described herein may be made, none of which depart from the spirit of the present invention. All such changes, modifications, and alterations should therefore be seen as within the scope of the present invention.

What is claimed is:

1. An image forming apparatus having an OCR function, comprising:
page number position information setting means for setting page number position information to indicate a position of a page number on an original document;
reading means for optically reading the original document to which the page number is given and generating image data of the original document;
image data storage means for storing the image data of each of a plurality of original documents generated by the reading means;
page number management means for comparing, from the image data of each of the plurality of original documents generated by the reading means, page numbers of the plurality of original documents subjected to an OCR processing based on the page number position information set by the page number position information setting means, detecting missing of an original document among the plurality of original documents read by the reading means, and determining that an abnormality exists in the image data corresponding to the missing original document and stored in the image data storage means; and
additional input processing means for causing the reading means to re-read the original document corresponding to the image data determined to be abnormal by the page number management means among the respective image data stored in the image data storage means.

2. The image forming apparatus of claim 1, wherein
the page number management means compares respective page numbers of the image data of the original document re-read by the reading means and the image data of the missing original document, and in a case where it is determined that an abnormality does not exist in the image data of the re-read original document, the page number management means writes the image data of the re-read original document into the image data storage means.

3. The image forming apparatus of claim 1, wherein
the page number position information setting means sets, as the page number position information, recommended information selected by a user among a plurality of recommended information.

4. The image forming apparatus of claim 1, wherein
the page number position information setting means sets, as the page number position information, data of a place designated by a user in the image data read by the reading means.

5. The image forming apparatus of claim 1, wherein
the page number position information setting means sets, as the page number position information, data of an area of the page number given to the original document read by the reading means.

6. The image forming apparatus of claim 1, further comprising a communication unit configured to transmit and receive the image data stored in the image data storage means to and from a terminal connected through a network.

7. A method of processing an image for an image forming apparatus having an OCR function, comprising the steps of:
generating page number position information by page number position information setting means for setting page number position information to indicate a position of a page number on an original document;
generating image data of the original document, to which the page number is given, by reading means for optically reading and processing the original document;
detecting missing of an original document among a plurality of original documents read by the reading means by page number management means for managing the page numbers by comparing, from the image data of each of the plurality of original documents generated by the reading means, page numbers of the plurality of original documents subjected to an OCR processing based on the page number position information set by the page number position information setting means;
determining, by the page number management means, that an abnormality exists in image data stored in image data storage means for storing data; and
causing, by additional input processing means for performing an additional input processing, the reading means to re-read the original document corresponding to the image data determined to be abnormal by the page number management means among the respective image data stored in the image data storage means.

8. The method of processing the image of claim 7, wherein
the page number management means compares respective page numbers of the image data of the original document re-read by the reading means and the image data of the missing original document, and determines whether an abnormality exists in the image data of the re-read original document, and
the page number management means writes, in a case where it is determined that the abnormality does not exist in the image data of the re-read original document, the image data of the re-read original document into the image data storage means.

9. The method of processing the image of claim 7, wherein
the page number position information setting means sets, as the page number position information, recommended information selected by a user among a plurality of recommended information.

10. The method of processing the image of claim 7, wherein
the page number position information setting means sets, as the page number position information, data of a place designated by a user in the image data read by the reading means.

11. The method of processing the image of claim 7, wherein
the page number position information setting means sets, as the page number position information, data of an area of the page number given to the original document read by the reading means.

12. The method of processing the image of claim 7, wherein
a communication unit configured to transmit and receive the image data stored in the image data storage means to and from a terminal connected through a network is further provided.

13. An image forming apparatus having an OCR function, comprising:
an operation panel to set page number position information to indicate a position of a page number on an original document;
a scanner to optically read the original document to which the page number is given and to generate image data of the original document;
a memory to store the image data of each of a plurality of original documents generated by the scanner;
an OCR processing unit to compare, from the image data of each of the plurality of original documents generated by the scanner, page numbers of the plurality of original documents subjected to an OCR processing based on the page number position information set by the operation panel, to detect missing of an original document among the plurality of original documents read by the scanner, and to determine that an abnormality exists in image data corresponding to the missing original document and stored in the memory; and
a control unit to cause the scanner to re-read the original document corresponding to the image data determined to be abnormal by the OCR processing unit among the respective image data stored in the memory.

14. The image forming apparatus of claim 13, wherein
the OCR processing unit compares respective page numbers of the image data of the original document re-read by the scanner and the image data of the missing original document, and in a case where it is determined that an abnormality does not exist in the image data of the re-read original document, the OCR processing unit writes the image data of the re-read original document into the memory.

15. The image forming apparatus of claim 13, wherein
the operation panel sets, as the page number position information, recommended information selected by a user among a plurality of recommended information.

16. The image forming apparatus of claim 13, wherein
the operation panel sets, as the page number position information, data of a place designated by a user in the image data read by the scanner.

17. The image forming apparatus of claim 13, wherein
the operation panel sets, as the page number position information, data of an area of the page number given to the original document read by the scanner.

18. The image forming apparatus of claim 13, further comprising a network communication unit configured to transmit and receive the image data stored in the memory to and from a terminal connected through a network.
